(19) United States
(12) Patent Application Publication
(10) Pub. No.: US 2021/0350356 A1
(43) Pub. Date: Nov. 11, 2021

(54) SYSTEMS AND METHODS FOR COMPUTER GAME TOURNAMENT USING DIGITAL ASSETS STORED IN A DIGITAL ASSET WALLET

(71) Applicant: RYU TECHNOLOGIES, INC., San Francisco, CA (US)

(72) Inventors: WYATT MUFSON, San Francisco, CA (US); Ross Krasner, San Francisco, CA (US)

(73) Assignee: RYU TECHNOLOGIES, INC., San Francisco, CA (US)

(21) Appl. No.: 16/868,533

(22) Filed: May 7, 2020

(51) Int. Cl. G06Q 20/36; G07F 17/32

(52) U.S. Cl. CPC G06Q 20/363; G07F 17/3276; G06Q 2220/00; G07F 17/3227; G07F 17/3269

(57) ABSTRACT

Embodiments of the invention are systems and methods for computer game tournaments using digital assets stored in a digital asset wallet, comprising: a multiplayer system on a middleware server, wherein a single-player computer game on a computing device uses an application programming interface to communicate with the multiplayer system and to become a multiplayer game; a core system on a middleware server, wherein the core system manages computer game tournaments for the computer game on the computing device; a database server, wherein the database server stores information for the multiplayer system and the core system; and a smart contract, wherein the smart contract is deployed on a blockchain and the smart contract stores digital asset balances for users.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

This invention is related to computer game tournaments using digital assets stored in a digital asset wallet.

### SUMMARY OF THE INVENTION

Embodiments of the invention are systems, methods, and computer readable storage mediums storing instructions for computer game tournaments using digital assets stored in a digital asset wallet, comprising: a multiplayer system on a middleware server, wherein a single-player computer game on a computing device uses an application programming interface to communicate with the multiplayer system and to become a multiplayer game; a core system on a middleware server, wherein the core system manages computer game tournaments for the computer game on the computing device; a database server, wherein the database server stores information for the multiplayer system and the core system; wherein digital assets are stored in a digital asset wallet.

### BRIEF DESCRIPTION OF THE DRAWINGS

FIG. 1 shows the system architecture for one embodiment, including a computer game and a digital asset wallet on a computing device, a multiplayer system and a core system on a middleware server, a database server, an application programming interface, and a smart contract deployed on a blockchain.

FIG. 2 shows an interaction diagram flowchart depicting a method for one embodiment, wherein a user signs up with a computer game to play digital asset tournaments against other users and creates a digital asset wallet.

FIG. 3 shows an interaction flowchart depicting a method for one embodiment, wherein a user purchases digital assets to participate in a digital asset tournament to compete against other users.

FIG. 4 shows an interaction flowchart depicting a method for one embodiment, wherein a user uses digital assets to join a computer game tournament to compete against other users.

FIG. 5 shows an interaction flowchart depicting a method for one embodiment, wherein a user used digital assets to participate in a computer game tournament to compete against other users and the system will determine and pay the winners.

FIG. 6 shows an interaction flowchart depicting a method for one embodiment, wherein a user signs up with a computer game to play digital asset tournaments, purchases digital assets, joins a tournament, and then the list of winners is paid digital assets after the tournament is concluded.

FIG. 7 shows an interaction flowchart depicting a method for one embodiment, wherein a user creates a digital asset tournament account in a computer game.

FIG. 8 shows the system architecture for one embodiment, including a computer game and a digital asset wallet on a computing device, a multiplayer system and a core system on a middleware server, a database server, and an application programming interface.

### DETAILED DESCRIPTION

Described herein are systems and methods to facilitate real-money tournaments using computer game competitions, where users will have the opportunity to win real-money prizes when competing against others in tournaments. Embodiments of the invention are systems and methods for mobile computer games with computer game tournaments on a blockchain.

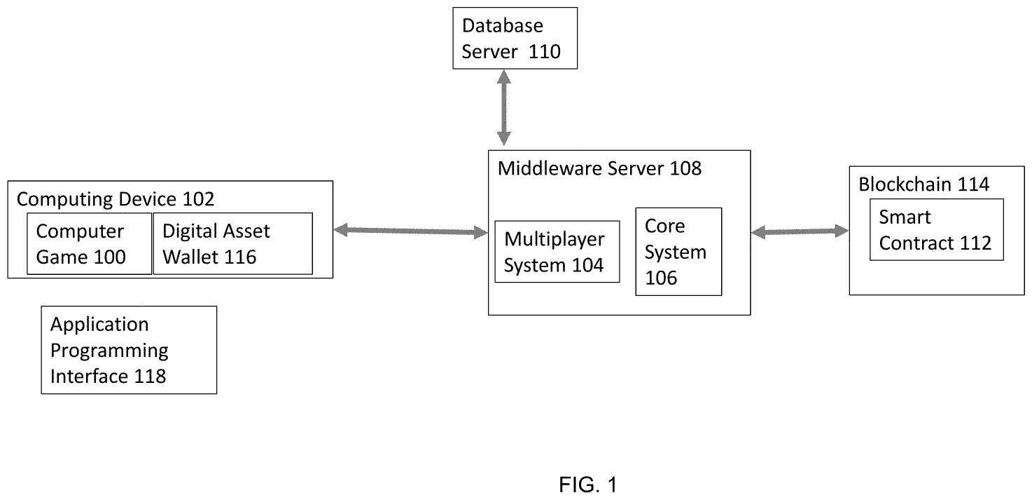

FIG. 1 shows the system architecture for one embodiment, including a computer game 100 and a digital asset wallet 116 on a computing device 102, a multiplayer system 104 and a core system 106 on a middleware server 108, a database server 110, an application programming interface 118, and a smart contract 112 deployed on a blockchain 114. Computer game 100 is installed on computing device 102. Multiple different computing devices are envisioned, including mobile devices, mobile phones, iOS devices such as the iPhone or iPad, desktop computers, laptops, handheld devices, television devices, gaming consoles, and other alternative devices. In one embodiment, computer game client 100 is developed by a third-party game developer who is separate from the developer of other components in FIG. 1. Users can play games using computer game 100 in single-player mode without communication with other components depicted in FIG. 1. If a user wishes to play a multiplayer game, the computer game 100 will communicate with multiplayer system 104. Multiplayer system 104 stores relevant information in database server 110. If the user wishes to play multiplayer games without playing a digital asset tournament (either in practice mode or for digital assets), then the only components involved are computer game client 100 and Multiplayer system 104. If a user wishes to play a digital asset tournament, then multiplayer system 104 will communicate with core system 106. Core System 106 also stores information in database server 110. In one embodiment, database server 110 is actually a cluster of databases. In one embodiment, database server 110 actually represents multiple database servers and the core system 106 and the multiplayer system 104 store information in different databases. In one embodiment, the multiplayer system 104 is developed by a third party developer that also created the computer game client 100. In one embodiment, if a user wishes to play a digital asset tournament in practice mode, the core system 106 does not need to contact the smart contract 112. If a user desires to play a digital asset tournament for digital assets, core system 106 has to communicate with the smart contract 112 which is deployed on a blockchain 114. In one embodiment, the digital assets are cryptocurrency tokens.

In one embodiment, a single game developer creates all of the components in the system. In an alternative embodiment, a game developer creates the computer game 100 and a platform developer creates the multiplayer system 104, the core server 106, and the smart contract 112. In yet another alternative embodiment, the game developer creates the computer game 100 and the multiplayer system 104, and the platform developer creates the core server 106 and the smart contract 112. The platform developer creates an Application Programming Interface (API) 118 for game developers to use when creating or modifying their computer game clients and/or multiplayer systems to work with the platform. The API 118 focuses on necessary information and transactions that need to be passed to the core server and the smart contract for digital asset tournaments. In one embodiment, a single API 118 supports both the computer game 100 and the multiplayer system 104. In an alternative embodiment, there is a separate API 118 for the computer game 100 and the multiplayer system 104.

In one embodiment, Wallet 116 is installed by the computer game on the client device to store digital assets to enable the user to participate in digital asset tournaments. In an alternative embodiment, Wallet 116 was previously installed and the computer game was configured to utilize the previously installed wallet.

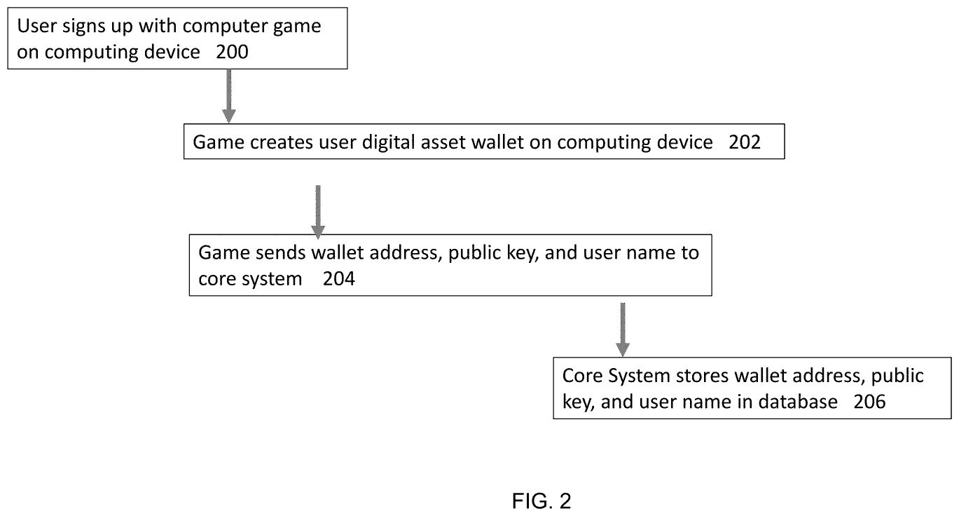

FIG. 2 shows an interaction diagram flowchart depicting a method for one embodiment, wherein a user signs up with a computer game to play digital asset tournaments against other users and creates a digital asset wallet. In step 200, the user signs up with the computer game on a computing device. In step 202, the computer game creates a digital asset wallet on the computing device. In an alternative embodiment, the computer game is instead configured to use an existing wallet on the computing device. In step 204, the computer game sends the wallet address and public key and user name to the core system on the middleware server. In step 206, the core system stores the wallet address, public key, and user name in the database server. By having the computer game automate the process of creating a digital asset wallet, this reduces the complexity burden on the user and minimizes the learning curve to create a digital asset wallet. In one embodiment, the Application Programming Interface (API) created by the developer that created the core server provided the configuration information necessary to create the digital asset wallet.

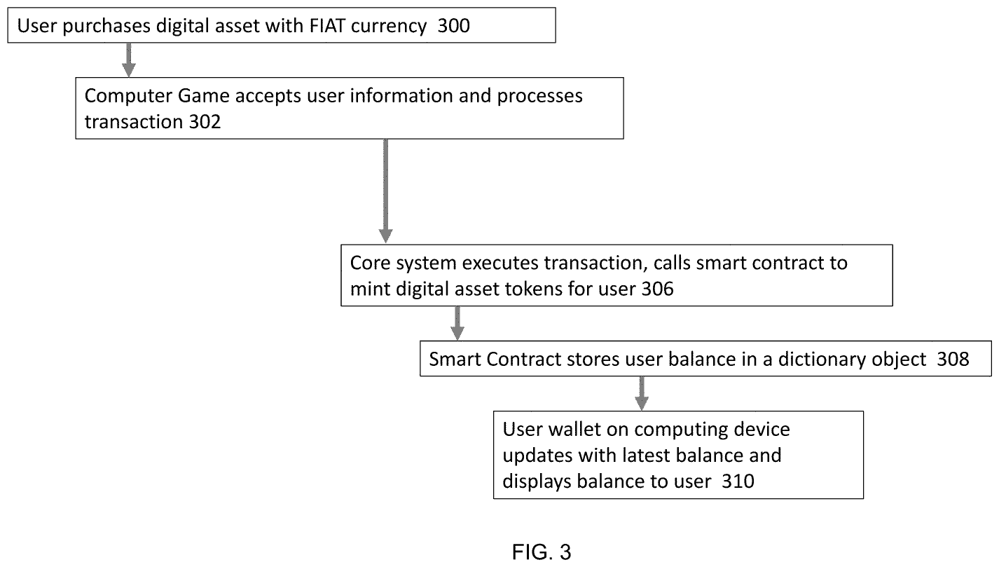

FIG. 3 shows an interaction flowchart depicting a method for one embodiment, wherein a user purchases digital assets to participate in a digital asset tournament to compete against other users. In step 300, user clicks on a screen to purchase digital assets with a FIAT currency such as dollars, euros, yen, etc. In step 302, the computer game accepts the user information and processes the transaction. In one embodiment, the computer game opens the Safari browser window if using Paypal for the transaction. In step 304, payment is accepted via Paypal in the Safari Browser window. In step 306, the core system executes the paypal transaction, calling the Smart Contract to mint the appropriate amount of new digital asset tokens for the user. In step 308, the smart contract updates the user's balance (or creates a new balance for a new user), storing the balance in a dictionary object. In one embodiment, the smart contract mints new tokens such as Ethereum ERC20 tokens or new Ontology tokens or the equivalent. In an alternative embodiment, the smart contract releases tokens that have already been created. In step 310, the user's digital asset wallet on the computing device updates with the latest balance and displays the updated balance to the user.

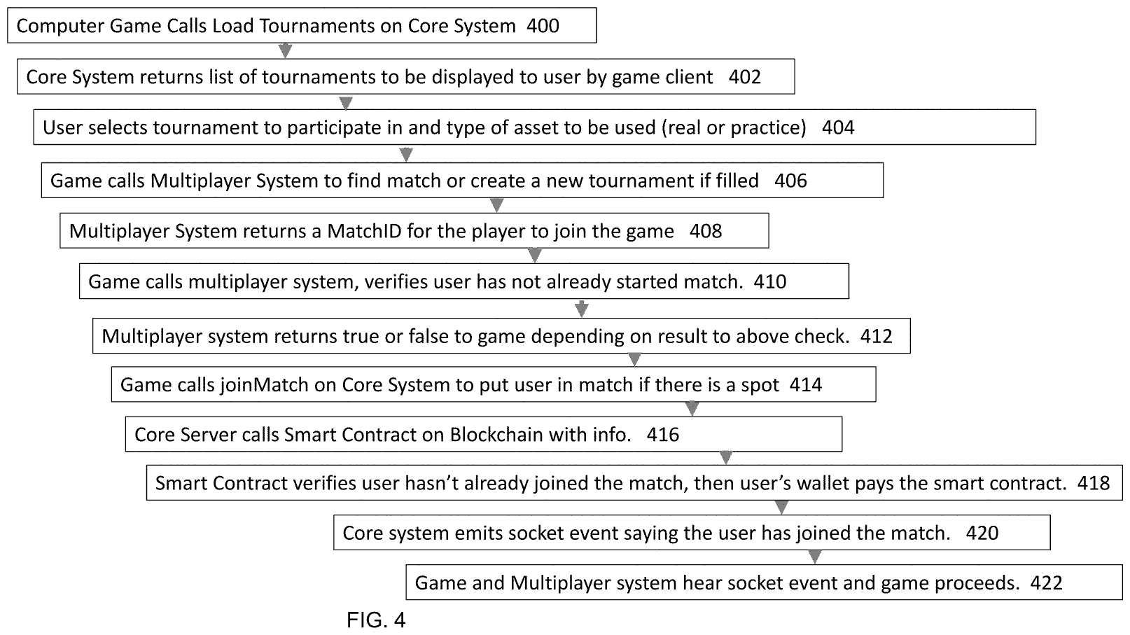

FIG. 4 shows an interaction flowchart depicting a method for one embodiment, wherein a user uses digital assets to participate in a digital asset tournament to compete against other users. In step 400, the computer game calls Load tournaments on the core system. In step 402, the core system returns the list of active tournaments to the computer game to be displayed to the user. In step 404, User selects the tournament to participate in and type of digital asset to be used (real or practice). In step 406, game finds a match with the Multiplayer System to find a match with corresponding tournament ID or to create a new tournament if all existing ones are filled. In step 408, Multiplayer System returns a MatchID for the player to join the game. In step 410, Game calls multiplayer system—checks to make sure the user has not already started the match with the given id. In one embodiment, verifying that the user has not already started the match is to prevent cheating or hacking of the game system. In step 412, Multiplayer system returns true or false to game depending on result to above check. In step 414, Game joins a match on Core Server to put user in match if there is a spot. In step 416, Core Server calls Smart Contract on the Blockchain with information. In one embodiment, the blockchain is the Ontology blockchain. In step 418, Core server emits socket event saying the user has joined the match. In step 420, Multiplayer System hears socket event. In step 422, Game hears event and match proceeds.

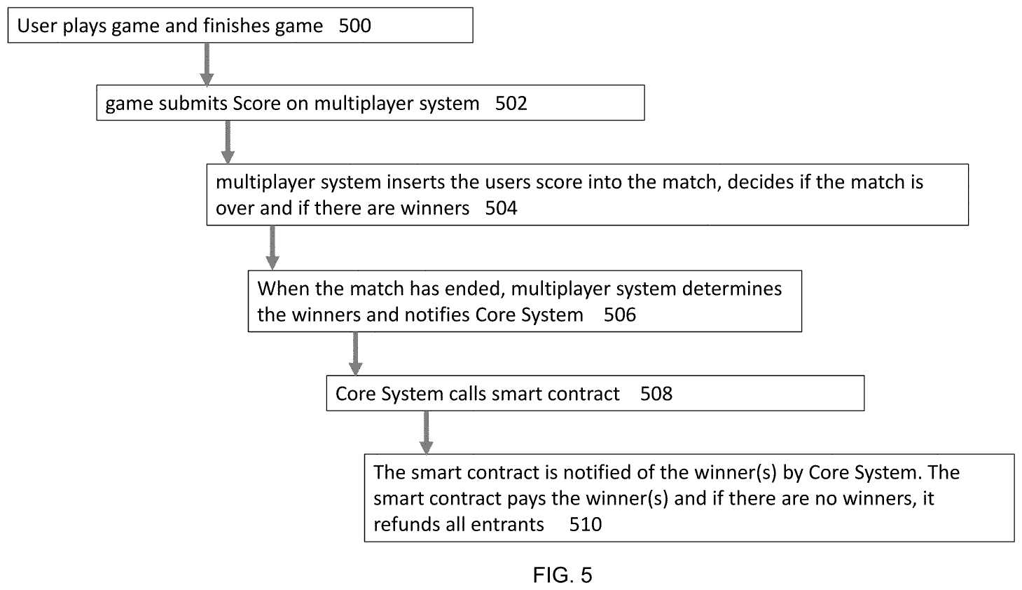

FIG. 5 shows an interaction flowchart depicting a method for one embodiment, wherein a user used digital assets to participate in a digital asset tournament to compete against other users and the system will determine and pay the winners. In step 500, the user plays the game and finishes the game. In step 502, the computer game submits the score on the multiplayer system. In step 504, the multiplayer system inserts the users score into the match, decides if the match is over and if there are winners. In step 506, when the match has ended, multiplayer system determines the winners and notifies the Core system. In step 508, Core System calls the smart contract. In step 510, The smart contract is notified of the winner(s) by Core system. The smart contract pays the winner(s) and if there are no winners, it refunds all entrants their entry fee.

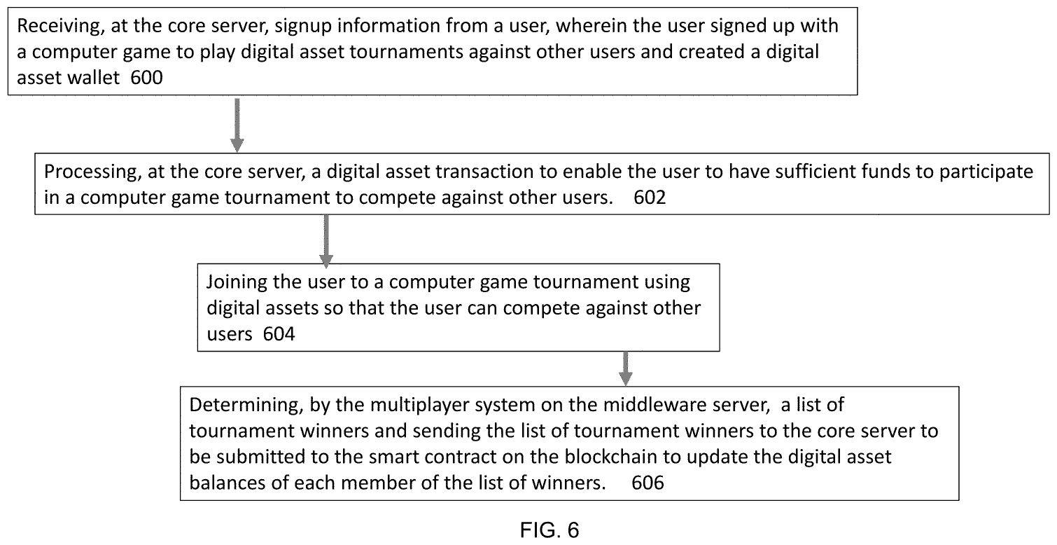

FIG. 6 shows an interaction flowchart depicting a method for one embodiment, wherein a user signs up with a computer game to play digital asset tournaments, purchases digital assets, joins a tournament, and then the list of winners is paid digital assets after the tournament is concluded. In step 600, Receiving, at the core server, signup information from a user, wherein the user signed up with a computer game to play digital asset tournaments against other users and created a digital asset wallet. Further details on step 600 can be found in FIG. 2 and steps 200-206. In step 602, processing, at the core server, a digital asset transaction to enable the user to have sufficient funds to participate in a computer game tournament to compete against other users. Further details on step 602 can be found in FIG. 3 and steps 300-310. In step 604, Joining the user to a computer game tournament using digital assets so that the user can compete against other users. Further details on step 604 can be found in FIG. 4 and steps 400-422. In step 606, determining, by the multiplayer system on the middleware server, a list of tournament winners and sending the list of tournament winners to the core server to be submitted to the smart contract on the blockchain to update the digital asset balances of each member of the list of winners. Further details on step 606 can be found in FIG. 5 and steps 500-510.

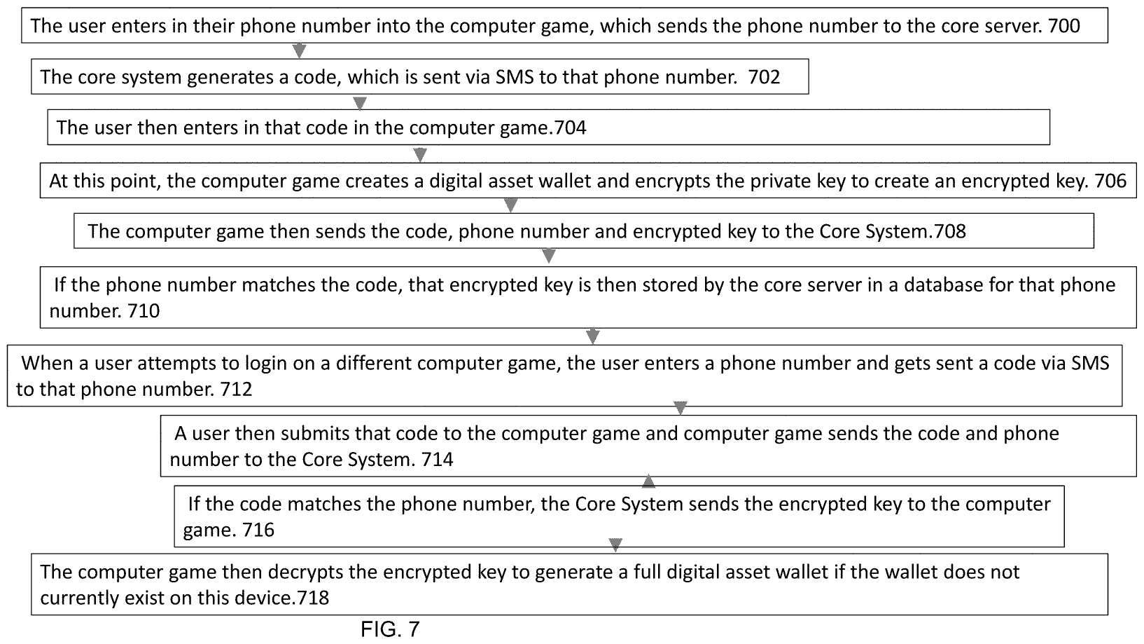

FIG. 7 shows an interaction flowchart depicting an alternative method for one embodiment, wherein a user creates a tournament account in a computer game. FIG. 7 depicts an alterative approach from the approach described in FIG. 2. In step 700, the user enters in their phone number into the computer game, which sends the phone number to the core server. In step 302, the core server generates a code, which is sent via SMS to that phone number. In step 704, the user then enters in that code. In step 706, the computer game creates a digital asset wallet and encrypts the private key to create an encrypted key. In step 708, the computer game then sends the code, phone number and encrypted key to the Core System. In step 710, if the phone number matches the code, that encrypted key is then stored by the core server in a database for that phone number. In step 712, when a user attempts to login on a different computer game, the user enters a phone number and gets sent a code via SMS to that phone number. In step 714, a user then submits that code and the code and phone number are sent to the Core System. In step 716, if the code matches the phone number, the Core System sends the encrypted key to the client. In step 718, the client then decrypts the encrypted key to generate a full digital asset wallet if the wallet does not currently exist on this device. In one embodiment, each instance of a computer game will have its own wallet; in an alternative embodiment, there is one wallet per device.

In one embodiment, the computer game is originally a single player computer game and is converted into a multiplayer game appropriate for a digital asset tournament. If the computer game is already timed and has a score, or is untimed but has an end state, utilizing the Application Programming Interface (API) to connect to the multiplayer system is sufficient to convert the single player game into a multiplayer game that can be run with a digital asset tournament. However, if the single player game is untimed without an end state, or timed without a score, then the single player game will have to be modified, i.e. adding an end state for an untimed game or add a score for a timed game in addition to using the API to connect to the multiplayer system in order to convert the single player game into a multiplayer game appropriate for a digital asset tournament.

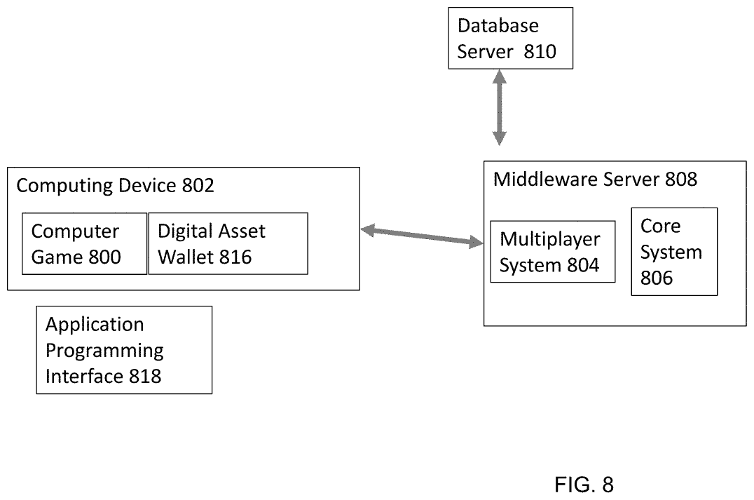

FIG. 8 shows the system architecture for an alternative embodiment to FIG. 1, including a computer game 800 and a digital asset wallet 816 on a computing device 802, a multiplayer system 804 and a core system 806 on a middleware server 808, a database server 810, an application programming interface 818.

FIG. 8 lacks having a smart contract deployed on a blockchain, instead the functionality that was performed by the smart contract on the blockchain in FIG. 1 is being performed in the core server and the database in FIG. 8. In one embodiment, the database in FIG. 8 is a database where the rows are cryptographically chained by hash pointers in a similar fashion to how blockchain transaction blocks are cryptographically chained by hash pointers. Cryptographically chaining the database rows by hash pointers provides a database with the transactional security protection that blockchain provides for transactions. In one embodiment, the same database is used for everything; in an alternative embodiment, multiple databases are being used.

Each user has a cryptocurrency wallet bunt into the game. When playing a tournament theft wallet creates and signs transactions which are broadcast to the core server. The core server verifies the content of the transaction alongside the API request to the multiplayer system and confirms that the user has authenticated the action to join the tournament. When connected to a blockchain, the transaction is broadcast to the chain. Once the transaction is confirmed on-chain, the user proceeds to the tournament. When using a database and not using a blockchain, once the core server verifies the transaction, the user proceeds to the tournament and the transaction is not broadcast to a blockchain. In both instances, whether using a blockchain and a database or a database alone, the signed transactions are cryptographically verified before users can proceed to a tournament.

Computer game 800 is installed on computing device 802. Multiple different computing devices are envisioned, including mobile devices, mobile phones, iOS devices such as the iPhone or iPad, desktop computers, laptops, handheld devices, television devices, gaming consoles, and other alternative devices. In one embodiment, computer game client 800 is developed by a third-party game developer who is separate from the developer of other components in FIG. 8. Users can play games using computer game 800 in single-player mode without communication with other components depicted in FIG. 8. If a user wishes to play a multiplayer game, the computer game 800 will communicate with multiplayer system 804. Multiplayer system 804 stores relevant information in database server 810. If the user wishes to play multiplayer games without playing a digital asset tournament (either in practice mode or for digital assets), then the only components involved are computer game client 800 and Multiplayer system 804. If a user wishes to play a digital asset tournament, then multiplayer system 804 will communicate with core system 806. Core System 106 also stores information in database server 810. In one embodiment, database server 810 is actually a cluster of databases. In one embodiment, database server 810 might actually be multiple different databases that each provide different functionality, for example, one database for reporting, one database for streaming transactions that are cryptographically chained, one data environment for big data analysis, etc. In one embodiment, database server 810 actually represents multiple database servers and the core system 806 and the multiplayer system 804 store information in different databases. In one embodiment, the multiplayer system 804 is developed by a third party developer that also created the computer game client 800. In one embodiment, the digital assets are cryptocurrency tokens.

In one embodiment, a single game developer creates all of the components in the system. In an alternative embodiment, a game developer creates the computer game 800 and a platform developer creates the multiplayer system 804, the core server 806, and the database server. In yet another alternative embodiment, the game developer creates the computer game 800 and the multiplayer system 804, and the platform developer creates the core server 806 and the database server. The platform developer creates an Application Programming Interface (API) 818 for game developers to use when creating or modifying their computer game clients and/or multiplayer systems to work with the platform. The API 818 focuses on necessary information and transactions that need to be passed to the core server and the smart contract for digital asset tournaments. In one embodiment, a single API 818 supports both the computer game 800 and the multiplayer system 804. In an alternative embodiment, there is a separate API 818 for the computer game 800 and the multiplayer system 804.

In one embodiment, Wallet 816 is installed by the computer game on the client device to store digital assets to enable the user to participate in digital asset tournaments. In an alternative embodiment, Wallet 816 was previously installed and the computer game was configured to utilize the previously installed wallet. In one embodiment, Wallet 816 is a software wallet. In an alternative environment, wallet 816 is a separate hardware device that communicates with the client device.

Blockchain technology offers numerous advantages over conventional solutions. Every tournament will be secured by a smart contract on a blockchain—making the transactions immutable, verifiable and immune to double-spending. A smart contract is executable code that runs on a blockchain.

Credit to both gamers and developers will be awarded within seconds of a match ending. The introduction of blockchain technology will add significant benefits to gamers and developers alike, primarily through improved transaction times, lower fees and the introduction of decentralization to the network. The described ecosystem will improve garners' experiences by providing an additional way for them to compete and have fun. Game developers can expect an increase in their user base, overall engagement and revenue. These systems and methods will have numerous advantages over current solutions.

Using a phone number and a two factor authentication code that is sent via SMS for login, greatly reduces the amount of time it takes to create an account, and login to an existing account. This entirely eliminates the need to remember a password.

In alternative embodiments, the multiplayer server and the core server are combined into a single server.

The smart contract is responsible for handling all of the logic behind distributing funds to the winners of matches based on the match events that are broadcast to it.

Users will also need to give access to their location in order to determine that they are in a location that is eligible for real-money tournaments in order to gain access to using digital assets.

The Server supplies an API for game developers to relay tournament events to the Smart Contract.

The Smart Contract will have these roles: Handling deposits and withdrawals of digital assets; and Handling tournament events and distributing funds accordingly. The contract keeps track of all matches taking place and allocates funds to the relevant parties (winners, developers).

Selecting a blockchain: Embodiments of the invention benefit from blockchains that provide quick transaction times, cheap transaction fees, and an easy development platform. An ideal blockchain publishes a new block within 30 seconds on average, meaning gaming transactions will be that quick. In one embodiment, transactions should be finalized after one block, so users will not have to wait for multiple block confirmations when using the system. In alternative embodiments, transactions are finalized after up to six blocks on average when using the system. Furthermore, it is recommended to use a blockchain that does not depend on a proof of work algorithm to reach consensus for efficiency reasons

When a user signs up they create a wallet on their device. The game itself, using the SDK, builds a new digital asset wallet that is stored locally. The wallet's public address and corresponding username is sent to the Core system and stored in a database.

Users then can pick a tournament with a set entry fee, prize, set of rules and range for the number of players who may participate in that tournament. They can then choose whether to enter the tournament with practice coin or digital assets. People only get matched up with others using the same type of currency.

In one embodiment, when a digital asset tournament is selected, the following functions are called by the client application. Alternative embodiments may have alternative function names and functionality may also be organized differently.

Finding a Match: The game calls the Multiplayer System to find a match with the corresponding tournament ID or creates a new one if all are filled. Returns a MatchId for the player to join.

Has a User Started a Match: The game calls the Multiplayer system to check to make sure the user has not already started the match with the given id.

Joining a Match: The game calls the Multiplayer system to put the user in the match if there is still a spot. The Multiplayer system then calls the Core System which calls the smart contract on the Ontology blockchain. First the smart contract checks to see if the user has already joined the match. If the user hasn't joined already, the user's wallet pays the smart contract the entry fee.

When a user calls the function to join a match, the wallet creates a transaction and passes that transaction to the Core System, which signs the transaction to invoke on the blockchain. The Backend pays the gas fee for the transaction. The Core System wallet signs the user's transaction and tells the blockchain. The Core System pays the blockchain transaction fee for each transaction. The blockchain transaction fee is a different currency from the digital assets being used in the system, so users only see the digital assets from the tournaments.

Digital Asset Tournament Ends and User submits score: When a user plays the game and finishes, the following functions are called by the client:

Submitting a Score: The game calls the Multiplayer system and inserts the users score into the match, then decides if the match is over and if there are winners. If match is expired (duration set at creation) or if all users have entered scores, it determines that the match is over. The winners are determined by the scores.

When the match has ended, the Multiplayer system notifies the Core system which calls the smart contract on the Ontology blockchain. The smart contract is notified of the winner(s) by Core system. The smart contract pays the winner(s) and if there are no winners, it refunds all entrants their entry fee.

The smart contract increases the winner's balance by the amount of the prize.

Buy Process: User clicks buy, it opens up paypal or another payment provider. Core system executes the payment. When the core system sees that they succeeded, Core System mints the tokens. The Game displays the balance on their wallet.

Withdraw Process: The user's identity is first verified to comply with various Know Your Customer (KYC), Anti-Money Laundering (AML) and other regulatory and compliance obligations. The identity verification process happens within the game itself. In an alternative embodiment, the identity verification and/or the withdrawal process happens in a separate application. The user then selects an amount of their digital asset to withdraw. When a user submits a withdrawal, the user's tokens are “burned” (destroyed) and the users receives their funds. One embodiment may be implemented using a conventional general purpose computer or a specialized digital computer or microprocessor(s) programmed according to the teachings of the present disclosure, as will be apparent to those skilled in the computer art. Appropriate software coding can readily be prepared by skilled programmers based on the teachings of the present disclosure, as will be apparent to those skilled in the software art. The invention may also be implemented by the preparation of integrated circuits or by interconnecting an appropriate network of conventional component circuits, as will be readily apparent to those skilled in the art.

One embodiment is a system for computer game tournaments using digital assets, comprising: a multiplayer system on a middleware server, wherein a single-player computer game on a computing device uses an application programming interface to communicate with the multiplayer system; a core system on a middleware server, wherein the core system manages computer game tournaments for the computer game on the computing device; and a database server, wherein the database server stores information for the multiplayer system and the core system; wherein the computer game uses a digital asset wallet to store digital assets.

One embodiment further comprises a smart contract, wherein the smart contract is deployed on a blockchain and the smart contract stores digital asset balances for users. In one embodiment, the computer game is a mobile phone app. In one embodiment, the computer game is a single player game that has an end state that is either timed with a score or untimed with a score. In one embodiment, the multiplayer system enrolled two or more users in a competition; and the multiplayer system compares end state information from the two or more users to determine a ranking between the two or more users based on score and time.

In one embodiment, the user can use the game client to accept game matches, check their balance, withdraw their funds, and view previous matches.

In one embodiment, a smart contract mints new digital assets when new digital assets are purchased by a user and the smart contact burns existing digital assets when a user cashes out existing digital assets. In one embodiment, the computer game installs a digital asset wallet when a user creates an account in the computer game to participate in computer game tournaments. In one embodiment, access, configuration, and management of a digital asset wallet is handled automatically by the computer game client. In one embodiment, the computer game is developed by a third-party.

Embodiments of the invention may be methods or may be non-transitory computer readable storage mediums storing computer program instructions, which when executed by at least one data processor of a computing device, cause the at least one data processor to implement a method. Some embodiments comprise: receiving, at the core server, signup information from a user, wherein the user signed up with a computer game to play digital asset tournaments against other users; processing, at the core server, a digital asset transaction to enable the user to have sufficient funds to participate in a computer game tournament to compete against other users; joining the user to a computer game tournament using digital assets so that the user can compete against other users; determining, by the multiplayer system on the middleware server, a list of tournament winners and sending the list of tournament winners to the core server to update the digital asset balances of each member of the list of winners.

One embodiment further comprises: receiving from the computer game on the computing device, the wallet address and public key and user name at the core system on the middleware server, wherein the computer game sent the wallet address and the public key and the user name after a user signed up with the computer game and created a digital asset wallet on the computing device; and storing the wallet address, public key, and user name in the database server.

One embodiment further comprises: receiving at the core system a notification that a user has made a payment via payment processor; creating the appropriate amount of new digital asset tokens for the user; updating the user's balance, storing the balance in a dictionary object; and wherein the user's digital asset wallet on the computing device updates with the latest balance.

One embodiment further comprises: receiving at the core system a request from the computer game requesting the list of active tournaments that can be joined and returning the list of active tournaments that can be joined to the computer game to be displayed to the user; receiving at the Multiplayer System a request from the user to find a match or to create a new tournament if all existing ones are filled and the type of currency to be used and Returning to the computer game a MatchID for the player to join the game; receiving a request at the Core Server to put the user in a match if there is a spot, wherein the Core Server calls a Smart Contract on the blockchain with tournament payment and information, and the Core server notifies the computer game and multiplayer system that the user has joined the tournament and the match may proceed.

One embodiment further comprises: receiving scores from the competitors at a multiplayer system on a middleware server; determining by the multiplayer system if the match is over and if there are winners; notifying a core system on the middleware server of the outcome of the match and the winners; and calling a smart contract deployed on a blockchain with the list of winners, wherein if there are no winners, the smart contract refunds all entrants their entry fee, otherwise the smart contract updates the digital asset balance by the amount that they won.

One embodiment includes a computer program product which is a storage medium (media) having instructions stored thereon/in which can be used to program a computer to perform any of the features present herein. The storage medium can include, but is not limited to, any type of disk including floppy disks, optical discs, DVD, CD-ROMs, micro drive, and magneto-optical disks, ROMs, RAMs, EPROMs, EEPROMs, DRAMs, flash memory of media or device suitable for storing instructions and/or data stored on any one of the computer readable medium (media). The present invention can include software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, execution environments/containers, and user applications.

Embodiments of the present invention can include providing code for implementing processes of the present invention. The providing can include providing code to a user in any manner. For example, the providing can include transmitting digital signals containing the code to a user; providing the code on a physical media to a user; or any other method of making the code available.

Embodiments of the present invention can include a computer-implemented method for transmitting code which can be executed at a computer to perform any of the processes of embodiments of the present invention. The transmitting can include transfer through any portion of a network, such as the Internet; through wires, the atmosphere or space; or any other type of transmission. The transmitting can include initiating a transmission of code, or causing the code to pass into any region or country from another region or country. For example, transmitting includes causing the transfer of code through a portion of a network as a result of previously addressing and sending data including the code to a user. A transmission to a user can include any transmission received by the user in any region or country, regardless of the location from which the transmission is sent.

Embodiments of the present invention can include a signal-containing code which can be executed at a computer to perform any of the processes of embodiments of the present invention. The signal can be transmitted through a network, such as the Internet; through wires, the atmosphere or space; or any other type of transmission. The entire signal need not be in transit at the same time. The signal can extend in time over the period of its transfer. The signal is not to be considered as a snapshot of what is currently in transit.

Other features, aspects and objects of the invention can be obtained from a review of the figures and the claims. It is to be understood that other embodiments of the invention can be developed and fall within the spirit and scope of the invention and claims. The foregoing description of preferred embodiments of the present invention has been provided for the purposes of illustration and description. It is not intended to be exhaustive or to limit the invention to the precise forms disclosed. Many modifications and variations will be apparent to the practitioner skilled in the art. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalents.

1. A system for computer game tournaments using digital assets, comprising:
a multiplayer system on a middleware server, wherein a single-player computer game on a computing device uses an application programming interface to communicate with the multiplayer system;
a core system on a middleware server, wherein the core system manages computer game tournaments for the computer game on the computing device;
and a database server, wherein the database server stores information for the multiplayer system and the core system;
wherein the computer game uses a digital asset wallet to store digital assets.

2. The system of claim 1, comprising:
a smart contract, wherein the smart contract is deployed on a blockchain and the smart contract stores digital asset balances for users.

3. The system of claim 1, wherein the computer game is a mobile phone app.

4. The system of claim 1, wherein the computer game is a single player game that has an end state that is either timed with a score or untimed with a score.

5. The system of claim 1, wherein the multiplayer system enrolled two or more users in a competition; and the multiplayer system compares end state information from the two or more users to determine a ranking between the two or more users based on score and time.

6. The system of claim 1, wherein the user can use the game client to accept game matches, check their balance, withdraw their funds, and view previous matches.

7. The system of claim 1, wherein a smart contract mints new digital assets when new digital assets are purchased by a user and the smart contact burns existing digital assets when a user cashes out existing digital assets.

8. The system of claim 1, wherein the computer game installs a digital asset wallet when a user creates an account in the computer game to participate in computer game tournaments.

9. The system of claim 1, wherein access, configuration, and management of a digital asset wallet is handled automatically by the computer game client.

10. The system of claim 1, wherein the computer game is developed by a third-party.

11. A method, comprising:
receiving, at the core server, signup information from a user, wherein the user signed up with a computer game to play digital asset tournaments against other users;
processing, at the core server, a digital asset transaction to enable the user to have sufficient funds to participate in a computer game tournament to compete against other users;
joining the user to a computer game tournament using digital assets so that the user can compete against other users;
determining, by the multiplayer system on the middleware server, a list of tournament winners and sending the list of tournament winners to the core server to update the digital asset balances of each member of the list of winners.

12. The method of claim 11, further comprising:
receiving from the computer game on the computing device, the wallet address and public key and user name at the core system on the middleware server, wherein the computer game sent the wallet address and the public key and the user name after a user signed up with the computer game and created a digital asset wallet on the computing device; and
storing the wallet address, public key, and user name in the database server.

13. The method of claim 11, further comprising:
receiving at the core system a notification that a user has made a payment via payment processor;
creating the appropriate amount of new digital asset tokens for the user;
updating the user's balance, storing the balance in a dictionary object; and
wherein the user's digital asset wallet on the computing device updates with the latest balance.

14. The method of claim 11, further comprising:
receiving at the core system a request from the computer game requesting the list of active tournaments that can be joined and returning the list of active tournaments that can be joined to the computer game to be displayed to the user;
receiving at the Multiplayer System a request from the user to find a match or to create a new tournament if all existing ones are filled and the type of currency to be used and Returning to the computer game a MatchID for the player to join the game;
receiving a request at the Core Server to put the user in a match if there is a spot, wherein the Core Server calls a Smart Contract on the blockchain with tournament payment and information, and the Core server notifies the computer game and multiplayer system that the user has joined the tournament and the match may proceed.

15. The method of claim 11, further comprising:
receiving scores from the competitors at a multiplayer system on a middleware server;
determining by the multiplayer system if the match is over and if there are winners;
notifying a core system on the middleware server of the outcome of the match and the winners;
and calling a smart contract deployed on a blockchain with the list of winners,
wherein if there are no winners, the smart contract refunds all entrants their entry fee, otherwise the smart contract updates the digital asset balance by the amount that they won.

16. A non-transitory computer readable storage medium storing computer program instructions, which when executed by at least one data processor of a computing device, cause the at least one data processor to implement a method, comprising: Receiving, at the core server, signup information from a user, wherein the user signed up with a computer game to play digital asset tournaments against other users and created a digital asset wallet;
processing, at the core server, a digital asset transaction to enable the user to have sufficient funds to participate in a computer game tournament to compete against other users;
joining the user to a computer game tournament using digital assets so that the user can compete against other users;
determining, by the multiplayer system on the middleware server, a list of tournament winners and sending the list of tournament winners to the core server to be submitted to the smart contract on the blockchain to update the digital asset balances of each member of the list of winners.

17. The computer readable storage medium of claim 16, further comprising:
receiving from the computer game on the computing device, the wallet address and public key and user name at the core system on the middleware server, wherein the computer game sent the wallet address and the public key and the user name after a user signed up with the computer game and created a digital asset wallet on the computing device; and
storing the wallet address, public key, and user name in the database server.

18. The computer readable storage medium of claim 16, further comprising:
receiving at the core system a notification that a user has made a payment via payment processor;
creating the appropriate amount of new digital asset tokens for the user;
storing balance information; and
wherein the user's digital asset wallet on the computing device updates with the latest balance.

19. The computer readable storage medium of claim 16, further comprising:
receiving at the core system a request from the computer game requesting the list of active tournaments that can be joined and Returning the list of active tournaments that can be joined to the computer game to be displayed to the user;
receiving at the Multiplayer System a request from the user to find a match or to create a new tournament if all existing ones are filled and the type of currency to be used and returning to the computer game a MatchID for the player to join the game;
receiving a request at the Core Server to put the user in a match if there is a spot, wherein the Core Server calls a Smart Contract on the blockchain with tournament payment and information, and the Core server notifies the computer game and multiplayer system that the user has joined the tournament and the match may proceed.

20. The method of claim 11, further comprising:
receiving scores from the competitors at a multiplayer system on a middleware server;
determining by the multiplayer system if the match is over and if there are winners;
notifying a core system on the middleware server of the outcome of the match and the winners;
and calling a smart contract deployed on a blockchain with the list of winners,
wherein if there are no winners, the smart contract refunds all entrants their entry fee, otherwise the smart contract updates the digital asset balance by the amount that they won.
